(19) United States
(12) Patent Application Publication
(10) Pub. No.: US 2026/0031612 A1
(43) Pub. Date: Jan. 29, 2026

(54) ELECTRO-STATIC DISCHARGE PROTECTION CIRCUIT

(71) Applicant: Qorvo US, Inc., Greensboro, NC (US)

(72) Inventor: Petteri Litmanen, Richardson, TX (US)

(21) Appl. No.: 19/249,375

(22) Filed: Jun. 25, 2025

Related U.S. Application Data
(60) Provisional application No. 63/674,539, filed on Jul. 23, 2024.

(51) Int. Cl. H02H 9/04

(52) U.S. Cl. CPC H02H 9/046

(57) ABSTRACT

One aspect of the present disclosure pertains to an electro-static discharge (ESD) protection circuit for providing ESD protection for gallium nitride (GaN)-based technologies. The ESD protection circuit includes a first transistor and a second transistor connected in parallel between a high pin and a central node. In some embodiments, the ESD protection circuit further includes a first diode connected between the central node and a low pin. In some embodiments, a first gate signal is coupled to a first gate of the first transistor, and a second gate signal is coupled to a second gate of the second transistor.

### CROSS-REFERENCE TO RELATED APPLICATION(S)

The present application claims the benefit of U.S. Provisional Application No. 63/674,539, filed Jul. 23, 2024, which is incorporated herein by reference in its entirety.

### FIELD OF THE DISCLOSURE

The technology disclosed herein relates generally to electro-static discharge (ESD) protection of high-power semiconductor devices, and more particularly to ESD protection circuits for high-power radio frequency (RF) devices.

### BACKGROUND

High-power radio frequency (RF) devices, and specifically gallium nitride (GaN)-based high-power RF devices, provide significant advantages such as high breakdown voltage, high power density, high operating and switching frequency, and high thermal conductivity, among others. GaN RF devices are attractive for use in a wide range of applications such as in radars, telecommunications, base stations, power amplifiers, etc.

While providing significant advantages, GaN-based devices and circuits, like other types of devices and circuits, are susceptible to and should be protected against ESD events, which can cause damage and/or catastrophic failure to devices and/or circuits. During an ESD event, a discharge current flows between an input/output (I/O) terminal and ground, and through vulnerable devices and/or circuitry of an integrated circuit (IC) device. To provide protection against such ESD events, ESD protection clamps may be designed and placed around core circuits or other vulnerable circuitry. However, current gate and drain ESD protection designs are very bulky, requiring a large number of diodes connected in series.

Another drawback of existing ESD protection designs is that they may fail to provide sufficient protection when used in a high pinch-off technology such as gallium nitride (GaN)-based technology. This is due, at least in part, to the large number of series diodes needed to keep a GaN ESD transistor (e.g., such as the clamp transistor) turned off during normal operation. For example, the on-resistance of the series diodes (the drain clamp diodes and the gate diodes) may be large enough to cause voltage to increase at the drain pad during an ESD strike and potentially cause circuit failure. Moreover, regardless of the drain clamp trigger mechanism, it is very difficult to achieve good ESD protection due to this fundamental issue. Thus, existing ESD protection techniques have not proved entirely satisfactory in all respects.

### SUMMARY

Embodiments of the present disclosure include systems, devices, and methods for providing an ESD protection circuit for GaN-based technologies, and more particularly for GaN-based depletion mode devices and circuits thereof.

In an exemplary aspect, an electro-static discharge (ESD) protection circuit includes a first transistor and a second transistor connected in parallel between a high pin and a central node. In some embodiments, the ESD protection circuit further includes a first diode connected between the central node and a low pin. In some embodiments, a first gate signal is coupled to a first gate of the first transistor, and a second gate signal is coupled to a second gate of the second transistor.

In some embodiments, the first transistor and the second transistor each include a depletion mode gallium nitride (GaN) transistor.

In some embodiments, a first drain of the first transistor and a second drain of the second transistor are connected to the high pin, and a first source of the first transistor and a second source of the second transistor are connected to each other via the central node.

In some embodiments, the ESD protection circuit further includes a second diode connected in series with the first diode. Further, an anode of the first diode is connected to the central node, and a cathode of the second diode is connected to the low pin.

In some embodiments, the high pin includes a drain pad that is further coupled to a drain of a third transistor protected by the ESD protection circuit.

In some embodiments, the low pin includes a ground node.

In some embodiments, the first transistor, the first diode, and the second diode provide a first current path between the high pin and the low pin, the second transistor, the first diode, and the second diode provide a second current path between the high pin and the low pin, and the first current path is parallel to the second current path.

In some embodiments, the ESD protection circuit further includes a first resistor coupled in series between the first gate signal and the first gate of the first transistor and a second resistor coupled in series between the second gate signal and the second gate of the second transistor.

In some embodiments, the ESD protection circuit is coupled to a first stage of a multi-stage amplifier, where the first gate signal corresponds to a second stage of the multi-stage amplifier, and where the second gate signal corresponds to a third stage of the multi-stage amplifier.

In some embodiments, the ESD protection circuit further includes a third diode, where an anode of the third diode is connected to the low pin, and where a cathode of the third diode is connected to the high pin.

In another exemplary aspect, a method includes providing an electro-static discharge (ESD) protection circuit including a first transistor and a second transistor connected in parallel between a high pin and a central node, where the ESD protection circuit further includes a first diode and a second diode connected in series between the central node and a low pin, where a first gate signal is coupled to a first gate of the first transistor, and where a second gate signal is coupled to a second gate of the second transistor. In some embodiments, the method further includes in response to an ESD event, causing ESD current to flow through one or both of a first current path between the high pin and the low pin and a second current path between the high pin and the low pin, where the first transistor, the first diode, and the second diode provide the first current path, and where the second transistor, the first diode, and the second diode provide the second current path.

In some embodiments, the ESD event includes a positive ESD strike between the high pin and the low pin, where the ESD current flows through both the first current path and the second current path.

In some embodiments, the positive ESD strike between the high pin and the low pin causes the first gate signal and the second gate signal to be floating.

In some embodiments, the ESD protection circuit is coupled to a first stage of a multi-stage amplifier, where the first gate signal corresponds to a gate of a second stage of the multi-stage amplifier, and where the second gate signal corresponds to a gate of a third stage of the multi-stage amplifier, where the ESD event includes a positive ESD strike between the high pin and the gate of the second stage of the multi-stage amplifier or between the high pin and the gate of the third stage of the multi-stage amplifier, and where the ESD current flows through one of the first current path and the second current path.

In some embodiments, the positive ESD strike between the high pin and the gate of the second stage of the multi-stage amplifier or between the high pin and the gate of the third stage of the multi-stage amplifier causes one of the first gate signal and the second gate signal to be floating.

In some embodiments, the first transistor and the second transistor each include a depletion mode gallium nitride (GaN) transistor.

In some embodiments, the high pin includes a drain pad that is further coupled to a drain of a third transistor protected by the ESD protection circuit, and the low pin includes a ground node.

In another exemplary aspect, an integrated circuit (IC) die includes internal circuitry and an electro-static discharge (ESD) protection circuit coupled to the internal circuitry. In some embodiments, the ESD protection circuit includes a first transistor and a second transistor connected in parallel between a high pin and a central node. In some embodiments, the ESD protection circuit further includes a first diode and a second diode connected in series between the central node and a low pin. In some embodiments, a first gate signal is coupled to a first gate of the first transistor, and a second gate signal is coupled to a second gate of the second transistor.

In some embodiments, the internal circuitry includes a GaN-based multi-stage amplifier.

In some embodiments, the first transistor and the second transistor each include a depletion mode gallium nitride (GaN) transistor.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 illustrates a block diagram of an integrated circuit (IC) die including an electro-static discharge (ESD) protection circuit, in accordance with embodiments of the present disclosure.

FIG. 2 illustrates an exemplary circuit diagram of a gate ESD protection circuit, in accordance with some embodiments.

FIG. 3 illustrates an exemplary circuit diagram of a drain ESD protection circuit, in accordance with some embodiments.

FIG. 4 illustrates an exemplary circuit diagram of an ESD protection circuit, including a combination of the gate ESD protection circuit and the drain ESD protection circuit, in accordance with some embodiments.

FIG. 5 illustrates an exemplary circuit diagram of a monolithic microwave integrated circuit (MMIC) including a multi-stage amplifier and an ESD protection circuit, in accordance with some embodiments.

FIG. 6A illustrates an exemplary circuit diagram of a MMIC including a multi-stage amplifier and an alternative ESD protection circuit, in accordance with some embodiments.

FIG. 6B illustrates an exemplary circuit diagram of a gate ESD protection circuit implemented in the MMIC of FIG. 6A, in accordance with some embodiments.

FIG. 7 illustrates a block diagram of an exemplary wireless communication device, according to some aspects of the present disclosure.

FIG. 8 illustrates a flow chart of a method of protecting internal circuitry of an IC die using an ESD protection circuit, according to some embodiments.

### DETAILED DESCRIPTION

For purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described systems, devices, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

An electro-static discharge (ESD) event causes a discharge current to flow between an input/output (I/O) terminal and ground. The discharge current may flow through vulnerable devices and/or circuitry, thereby resulting in damage and/or catastrophic failure of the devices and/or circuitry. Generally, protection against such ESD events is provided by placing ESD protection clamps around core circuits and/or around other vulnerable circuitry. Often, ESD protection clamps consist of a gate diode stack used for gate ESD protection and a reverse-biased drain diode or a voltage-triggered clamp used for drain ESD protection. Gate diode stacks, which in one example may be implemented using six diodes, are very bulky. For drain ESD protection, single reverse-biased drain diodes do not protect in the positive voltage direction until the diode reaches breakdown, while voltage-triggered clamps also require a large number of diodes (e.g., such as four or five) in series to keep the clamp transistor turned off during normal operation.

In high pinch-off technology such as gallium nitride (GaN)-based technology, existing ESD protection circuits also fail to provide good protection because of the large number of series diodes needed to keep a GaN ESD clamp transistor turned off during normal operation (e.g., when there is no ESD strike). For example, during a positive ESD event at a drain pad, with the gate pad grounded, current may flow through multiple drain clamp diodes and multiple gate diodes, while keeping the drain voltage below a breakdown voltage. However, the on-resistance of the drain clamp diodes and the gate diodes is large enough to cause the voltage to increase at the drain pad and potentially cause circuit failure. Further, regardless of the drain clamp trigger mechanism, it remains very difficult to achieve good ESD protection due to this fundamental issue. Thus, existing ESD protection techniques have not proved entirely satisfactory in all respects.

Embodiments of the present disclosure offer advantages over the existing art, though it is understood that other embodiments may offer different advantages, not all advantages are necessarily discussed herein, and no particular advantage is required for all embodiments. For example, embodiments discussed herein include systems, devices, and methods for providing a triggerless ESD protection circuit for GaN-based technologies, and more particularly for GaN-based depletion mode devices and circuits thereof, that effectively serve to overcome various shortcomings of existing implementations. In some embodiments, the number of series diodes needed to keep an ESD transistor turned off during normal operation (e.g., when there is no ESD strike) is reduced by advantageously using the negative gate voltage of a depletion mode GaN transistor, which operates as a normally-on transistor. The use of the negative gate voltage eliminates the need for a trigger, thereby providing the triggerless ESD protection circuit, and improves the overall robustness of the design. Various embodiments of the ESD protection circuit disclosed herein are discussed in view of an ESD test defined as applying an ESD strike between any two pins of a die while the remaining pins are floating. By way of example, one of the two pins between which the ESD strike is applied will include an ESD ground, which in some cases may be alternatively referred to as ground, ground node, or ground pin. Embodiments disclosed herein include gate and drain ESD protection cells, or gate and drain ESD protection circuits, that utilize multiple gate signals to guarantee a floating gate and keep the cell shorted to a backside ground. While not limited thereto, aspects of the present disclosure may be discussed with reference to implementation in a multi-stage amplifier such as a low-noise amplifier (LNA) or a power amplifier (PA). In some cases, aspects of the present disclosure may be implemented in such a multi-stage amplifier fabricated as part of a monolithic microwave integrated circuit (MMIC). Various examples of the multi-stage amplifier provided below are discussed with reference to a three stage amplifier. It will be understood, however, that embodiments of the present disclosure are not limited to three stage amplifiers. In some case, the multi-stage amplifier may include more than three stages or less than three stages (e.g., at least two stages).

In some embodiments, a gate ESD protection circuit includes two parallel current paths which are controlled by two separate gate signals. In some cases, the two separate gate signals may be electrically the same but have separate pins. By way of example, if the gate ESD protection circuit is used to protect a gate of a first stage of a multi-stage amplifier (‘Gate 1’), then gates of a second stage (‘Gate 2’) and a third stage (‘Gate 3’) of the multi-stage amplifier are connected to GaN transistors (Q1 and Q2) in the two parallel current paths of the gate ESD protection circuit. If the gate ESD protection circuit is used to protect Gate 2, then Gate 1 and Gate 3 are connected to the GaN transistors (Q1 and Q2) in the two parallel current paths of the gate ESD protection circuit. Similarly, if the gate ESD protection circuit is used to protect Gate 3, then Gate 1 and Gate 2 are connected to the GaN transistors (Q1 and Q2) in the two parallel current paths of the gate ESD protection circuit. High value resistors (e.g., around 10 kOhms) at the gates of the GaN transistors (Q1 and Q2) provide radio frequency (RF) isolation to eliminate undesired feedback between amplifier stages. An optional capacitive trigger, coupled to gates of the GaN transistors (Q1 and Q2), may be provided in some embodiments. In accordance with the disclosed embodiments, the use of triggerless gate ESD protection circuit serves to eliminate some series diodes (e.g., one or two) compared to diode stacks of some existing implementations.

In some examples, a drain ESD protection circuit, like the gate ESD protection circuit, also includes two parallel current paths which are controlled by two separate gate signals with separate pins. By way of example, if the drain ESD protection circuit is used to protect a drain of a first stage of a multi-stage amplifier (‘Drain 1’), then gates of a second stage (‘Gate 2’) and a third stage (‘Gate 3’) of the multi-stage amplifier are connected to GaN transistors (Q1 and Q2) in the two parallel current paths of the drain ESD protection circuit. If the drain ESD protection circuit is used to protect a drain of a second stage of the multi-stage amplifier (‘Drain 2’), then Gate 1 and Gate 3 are connected to the GaN transistors (Q1 and Q2) in the two parallel current paths of the drain ESD protection circuit. Similarly, if the drain ESD protection circuit is used to protect a drain of a third stage of the multi-stage amplifier (‘Drain 3’), then Gate 1 and Gate 2 are connected to the GaN transistors (Q1 and Q2) in the two parallel current paths of the drain ESD protection circuit. In the case of the drain ESD protection circuit, and in some embodiments, the use of triggerless drain ESD protection serves to eliminate a greater number of series diodes (e.g., four or five) as compared to at least some existing ESD drain clamps. Thus, in some embodiments, the drain ESD protection circuit may provide a more significant improvement, and a more significant reduction in cell size, over existing implementations as compared to the gate ESD protection circuit. It is also noted that like the gate ESD protection circuit, high value resistors may also be implemented in the drain ESD protection circuit to provide RF isolation. Also, an optional capacitive trigger, coupled to gates of the GaN transistors (Q1 and Q2), may be provided in some embodiments. Additional details of embodiments of the present disclosure are provided below, and additional benefits and/or other advantages will become apparent to those skilled in the art having benefit of the present disclosure.

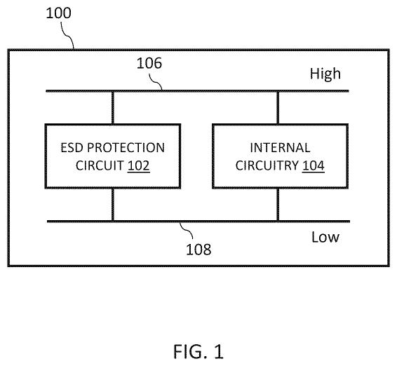

Referring to FIG. 1, illustrated therein is a block diagram of an integrated circuit (IC) die 100, in accordance with embodiments of the present disclosure. In various examples, the IC die 100 may include an ESD protection circuit 102 and internal circuitry 104, both of which are coupled to a high pin 106 and a low pin 108. In some embodiments, the ESD protection circuit 102 may include a gate ESD protection circuit, a drain ESD protection circuit, or a combination thereof. The ESD protection circuit 102, in particular, is provided to protect the internal circuitry 104 from ESD events that could otherwise damage and/or cause catastrophic failure of the internal circuitry 104. In accordance with the embodiments disclosed herein, the IC die 100, including the ESD protection circuit 102 and the internal circuitry 104, may include GaN-based devices and circuits. In some embodiments, the GaN-based devices and circuits may further include GaN-based depletion mode devices and circuits thereof. In some examples, the internal circuitry 104 may implement any of a variety of GaN-based circuits such as PAS, switches, mixers, LNAs, filters, duplexers, multiplexers, modulators, multipliers, transceivers, or other GaN-based circuits and/or devices. Further, in some embodiments, the IC die 100 may include an MMIC die that implements the ESD protection circuit 102 and the internal circuitry 104.

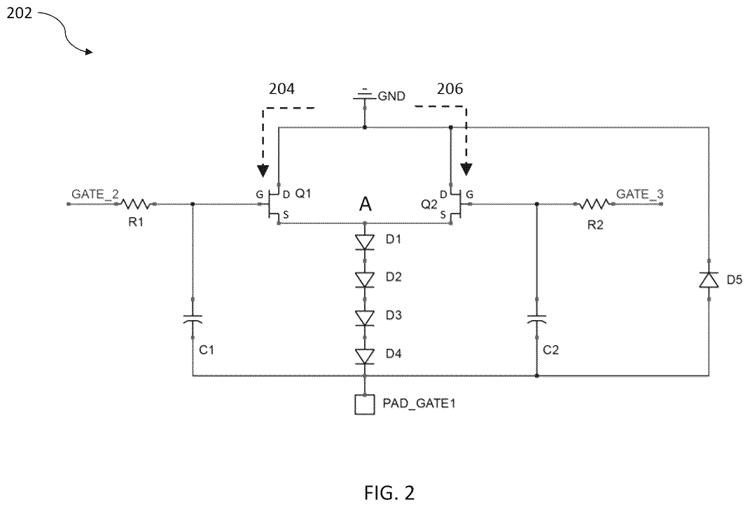

With reference to FIG. 2, illustrated therein is an exemplary circuit diagram of a gate ESD protection circuit 202, which in some embodiments may be included as part of the ESD protection circuit 102 of FIG. 1. The gate of the depletion mode GaN transistor being protected (gate of the first stage of a multi-stage amplifier ‘Gate 1’ in this example, not shown) may be coupled to the gate pad (PAD_GATE1) shown in FIG. 2. During normal operation, the gate of a depletion mode GaN transistor is not biased above zero volts (0V). Thus, in the gate ESD protection circuit 202, the gate pad (PAD_GATE1) is the most negative pin (the low pin) of the gate ESD protection circuit 202, and a ground node (GND) is the most positive pin (the high pin) of the gate ESD protection circuit 202. The ground node (GND) may include a backside ground, in some embodiments. While the example of FIG. 2 is shown with respect to the gate of a first stage of a multi-stage amplifier (‘Gate 1’), in some embodiments, similar gate ESD protection circuits may be used to protect a gate of a second stage of the multi-stage amplifier (‘Gate 2’), a gate of a third stage of the multi-stage amplifier (‘Gate 3’), or more generally a gate of any stage of a multi-stage amplifier, as discussed in more detail below.

As shown, the gate ESD protection circuit 202 has two depletion mode GaN transistors Q1, Q2 connected in parallel between the high pin (GND) and a central node ‘A’. In particular, a drain ‘D’ of each of the transistors Q1, Q2 is coupled to the high pin (GND), and a source ‘S’ of each of the transistors Q1, Q2 are coupled to each other via the node ‘A’. In the example shown, four diodes D1, D2, D3, D4 are connected in series between the node ‘A’ and the low pin (PAD_GATE1), with an anode of the diode D1 connected to the node ‘A’ and a cathode of the diode D4 connected to the low pin. In some embodiments, the diodes D1, D2, D3, D4, together with negative gate voltage provided by gate signals of Gate 2 and/or Gate 3 (as described below), may be used to keep the transistors Q1, Q2 off during normal operation (e.g., when there is no ESD strike). In contrast to some existing implementations, the triggerless operation of the gate ESD protection circuit 202, provided by advantageous use of the negative gate voltage at the gate signals of Gate 2 and/or Gate 3, provides robust ESD protection with fewer series diodes. The gate ESD protection circuit 202 thus has two parallel current paths 204 and 206, the first path 204 through transistor Q1 and the four diodes D1-D4, and the second path 206 through transistor Q2 and the four diodes D1-D4.

In various embodiments, the transistors Q1, Q2 are controlled by two separate gate signals (the gate signals of Gate 2, Gate 3). In the example shown, since Gate 1 is being protected, a gate signal of Gate 2 is coupled to the gate of the transistor Q1 with a resistor R1 coupled in series between Gate 2 and the gate of the transistor Q1, and a gate signal of Gate 3 is coupled to the gate of the transistor Q2 with a resistor R2 coupled in series between Gate 3 and the gate of the transistor Q2. In some embodiments, the resistors R1, R2 are high value resistors with a resistance in a range of between about 9-11 kOhms. In at least some examples, the resistors R1, R2 have a resistance of about 10 kOhms. The resistors R1, R2 provide RF isolation to eliminate feedback between amplifier stages, as noted above. In some examples, the gate ESD protection circuit 202 may optionally include capacitors C1, C2 coupled between respective gates of the transistors Q1, Q2 and the low pin (PAD_GATE1). These optional capacitors C1, C2 provide a capacitive trigger for the transistors Q1, Q2. In various embodiments, the gate ESD protection circuit 202 further includes diode D5 oriented in a reverse direction as compared to the diodes D1-D4, where an anode of the diode D5 is connected to the low pin (PAD_GATE1) and a cathode of the diode D5 connected to the high pin (GND). Because during normal operation (e.g., when there is no ESD strike), the gate of a depletion mode GaN transistor is not biased above zero volts (0V), the single diode D5 oriented in the reverse direction is sufficient to protect during a negative ESD strike between the low pin and the high pin.

During normal operating conditions (e.g., such as when there is no ESD strike), the gate ESD protection circuit 202 normally remains in an off-state (e.g., not conducting current). By way of example, one or both of the gate signals of Gate 2 and Gate 3 that are coupled to the gate of the transistors Q1, Q2 may be set to a negative gate voltage during normal operation (e.g., when there is no ESD strike). The negative gate voltage at Gate 2 and/or Gate 3 may in some cases be equal to the threshold voltage (turn-off voltage) of respective ones of second and third stage GaN transistors of the multi-stage amplifier. More particularly, the negative gate voltage provided at Gate 2 and/or Gate 3 is thus advantageously used to keep the transistors Q1, Q2 in an off-state (or at least a partially off-state) during normal operation, thereby reducing the total number of series diodes needed between the node ‘A’ and the low pin to ensure a substantially fully off-state of the transistors Q1, Q2. During a positive ESD strike between the high pin and the low pin, Gate 2 and Gate 3 will be floating. This ensures that the two transistors Q1, Q2 will be turned on (be in an on-state) to provide a minimum resistance path to ground for the ESD strike. In such an example, the current will flow through both parallel current paths 204, 206 to effectively sink the ESD current and protect internal circuitry. Moreover, having the two parallel current paths 204, 206 provides redundancy in the case of an ESD strike between other pairs of pins. For example, during a positive ESD strike between the high pin (GND) and Gate 2, Gate 3 will remain floating, ensuring that the transistor Q2 will be turned on and current will flow primarily through the current path 206 to still effectively sink the ESD current. Similarly, during a positive ESD strike between the high pin (GND) and Gate 3, Gate 2 will remain floating, ensuring that the transistor Q1 will be turned on and current will flow primarily through the current path 204 to once again effectively sink the ESD current. The gate ESD protection circuit 202 thus guarantees that at least one minimum resistance path to ground for the ESD strike, provided by at least one of the transistors Q1, Q2, is always available. In various embodiments, this enables the gate ESD protection circuit 202 to provide a minimum of 1,500V human-body model (HBM) of protection at the gate pad (PAD_GATE1).

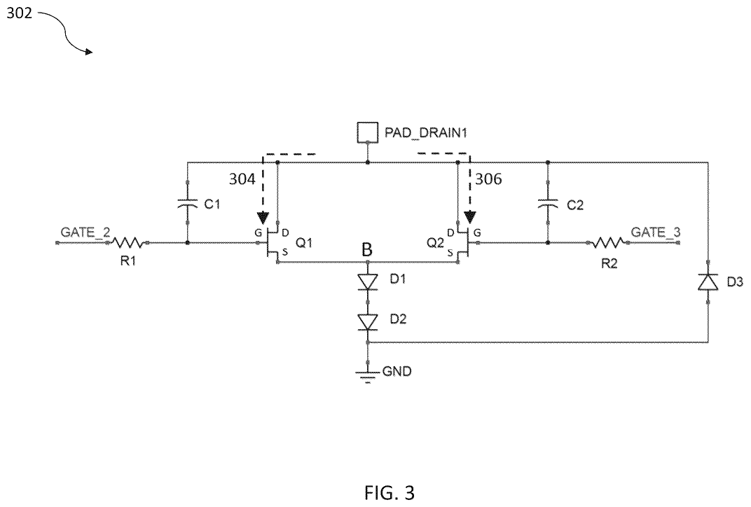

With reference now to FIG. 3, illustrated therein is an exemplary circuit diagram of a drain ESD protection circuit 302, which in some embodiments may be included as part of the ESD protection circuit 102 of FIG. 1. The drain of the depletion mode GaN transistor being protected (drain of the first stage of a multi-stage amplifier ‘Drain 1’ in this example, not shown) may be coupled to the drain pad (PAD_DRAIN1) shown in FIG. 3. During normal operation, the drain of a depletion mode GaN transistor is not biased below zero volts (0V). Thus, in the drain ESD protection circuit 302, the drain pad (PAD_DRAIN1) is the most positive pin (the high pin) of the drain ESD protection circuit 302, and a ground node (GND) is the most negative pin (the low pin) of the drain ESD protection circuit 302. As discussed above, the ground node (GND) may include a backside ground, in some embodiments. While the example of FIG. 3 is shown with respect to the drain of a first stage of a multi-stage amplifier (‘Drain 1’), in some embodiments, similar drain ESD protection circuits may be used to protect a drain of a second stage of the multi-stage amplifier (‘Drain 2’), a drain of a third stage of the multi-stage amplifier (‘Drain 3’), or more generally a drain of any stage of a multi-stage amplifier, as discussed in more detail below.

Like the gate ESD protection circuit 202, the drain ESD protection circuit 302 has two depletion mode GaN transistors Q1, Q2, which may be similar to the transistors Q1, Q2 discussed above with reference to the gate ESD protection circuit 202. In the drain ESD protection circuit 302, the transistors Q1, Q2 are connected in parallel between the high pin (PAD_DRAIN1) and a central node ‘B’. In particular, a drain ‘D’ of each of the transistors Q1, Q2 is coupled to the high pin (PAD_DRAIN1), and a source ‘S’ of each of the transistors Q1, Q2 are coupled to each other via the node ‘B’. In the example shown, two diodes D1, D2 are connected in series between the node ‘B’ and the low pin (GND), with an anode of the diode D1 connected to the node ‘B’ and a cathode of the diode D2 connected to the low pin. The diodes D1, D2 may be similar to the diodes D1-D4 discussed above with reference to the gate ESD protection circuit 202. In some embodiments, the diodes D1, D2, together with negative gate voltage provided by gate signals of Gate 2 and/or Gate 3, may be used to keep the transistors Q1, Q2 off during normal operation (e.g., when there is no ESD strike). In at least some cases, the drain ESD protection circuit 302 may alternatively be implemented with a single diode D1 between the node ‘B’ and the low pin (GND), while still keeping the transistors Q1, Q2 off during normal operation. In contrast to some existing implementations, the triggerless operation of the drain ESD protection circuit 302, provided by advantageous use of the negative gate voltage at the gate signals of Gate 2 and/or Gate 3, provides robust ESD protection and eliminates a larger number of diodes, and thus provides a more significant reduction in cell size, over existing implementations as compared to the gate ESD protection circuit 202. The drain ESD protection circuit 302 thus has two parallel current paths 304 and 306, the first path 304 through transistor Q1 and the two diodes D1-D2, and the second path 306 through transistor Q2 and the two diodes D1-D2.

Once again, like the gate ESD protection circuit 202, the transistors Q1, Q2 of the drain ESD protection circuit 302 are controlled by two separate gate signals (the gate signals of Gate 2, Gate 3). In the example shown, since Drain 1 is being protected, a gate signal of Gate 2 is coupled to the gate of the transistor Q1 with a resistor R1 coupled in series between Gate 2 and the gate of the transistor Q1, and a gate signal of Gate 3 is coupled to the gate of the transistor Q2 with a resistor R2 coupled in series between Gate 3 and the gate of the transistor Q2. The resistors R1, R2 may be similar to the resistors described above with reference to the gate ESD protection circuit 202. Thus, the resistors R1, R2 of the drain ESD protection circuit 302 may likewise include high value resistors with a resistance in a range of between about 9-11 kOhms. In at least some examples, the resistors R1, R2 have a resistance of about 10 kOhms. As noted above, the resistors R1, R2 provide RF isolation to eliminate feedback between amplifier stages. In some examples, the drain ESD protection circuit 302 may optionally include capacitors C1, C2 coupled between respective gates of the transistors Q1, Q2 and the high pin (PAD_DRAIN1). As described above, the optional capacitors C1, C2 provide a capacitive trigger for the transistors Q1, Q2. In various embodiments, the drain ESD protection circuit 302 further includes diode D3 oriented in a reverse direction as compared to the diodes D1-D2, where an anode of the diode D3 is connected to the low pin (GND) and a cathode of the diode D3 connected to the high pin (PAD_DRAIN1). The diode D3 in the drain ESD protection circuit 302 may be similar to the diode D5 in the gate ESD protection circuit 202. Since during normal operation (e.g., when there is no ESD strike), the drain of a depletion mode GaN transistor is not biased below zero volts (0V), the single diode D3 oriented in the reverse direction is sufficient to protect during a negative ESD strike between the low pin and the high pin.

During normal operating conditions (e.g., such as when there is no ESD strike), the drain ESD protection circuit 302 normally remains in an off-state (e.g., not conducting current). By way of example, one or both of the gate signals of Gate 2 and Gate 3 that are coupled to the gate of the transistors Q1, Q2 may be set to a negative gate voltage during normal operation (e.g., when there is no ESD strike). The negative gate voltage at Gate 2 and/or Gate 3 may in some cases be equal to the threshold voltage (turn-off voltage) of respective ones of second and third stage GaN transistors of the multi-stage amplifier. More particularly, the negative gate voltage provided at Gate 2 and/or Gate 3 is thus advantageously used to keep the transistors Q1, Q2 in an off-state (or at least a partially off-state) during normal operation, thereby reducing the total number of series diodes needed between the node ‘B’ and the low pin to ensure a substantially fully off-state of the transistors Q1, Q2. During a positive ESD strike between the high pin and the low pin, Gate 2 and Gate 3 will be floating. This ensures that the two transistors Q1, Q2 will be turned on (be in an on-state) to provide a minimum resistance path to ground for the ESD strike. In such an example, the current will flow through both parallel current paths 304, 306 to effectively sink the ESD current. Having two parallel current paths 304, 306, like the two parallel current paths 204, 206 discussed above, provides redundancy in the case of an ESD strike between other pairs of pins. For example, during a positive ESD strike between the high pin (PAD_DRAIN1) and Gate 2, Gate 3 will remain floating, ensuring that the transistor Q2 will be turned on and current will flow primarily through the current path 306 to still effectively sink the ESD current. Similarly, during a positive ESD strike between the high pin (PAD_DRAIN1) and Gate 3, Gate 2 will remain floating, ensuring that the transistor Q1 will be turned on and current will flow primarily through the current path 304 to once again effectively sink the ESD current. The drain ESD protection circuit 302 thus guarantees that at least one minimum resistance path to ground for the ESD strike, provided by at least one of the transistors Q1, Q2, is always available. In various embodiments, this enables the drain ESD protection circuit 302 to provide a minimum of 1,500V HBM of protection at the drain pad (PAD_DRAIN1).

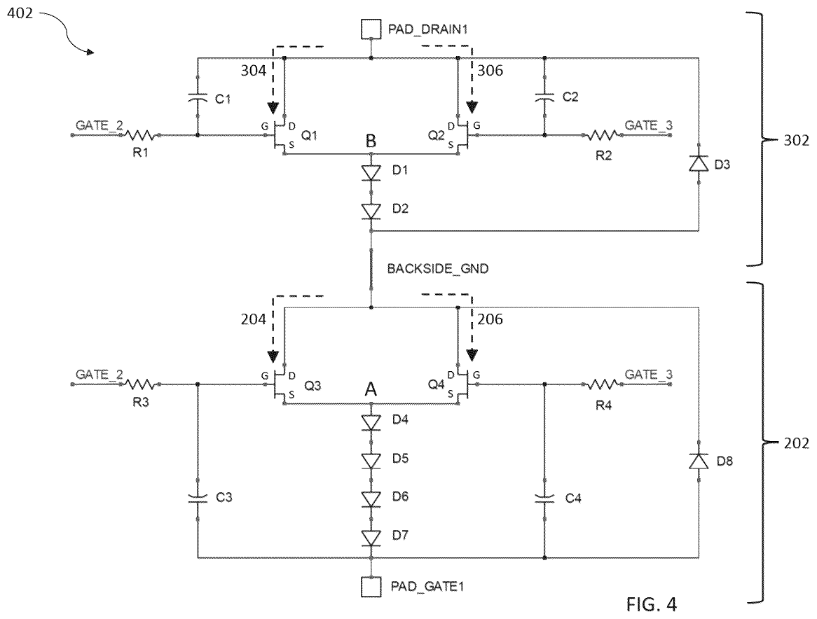

Referring now to FIG. 4, illustrated therein is an exemplary circuit diagram of an ESD protection circuit 402, which in some embodiments may be included as part of the ESD protection circuit 102 of FIG. 1. As shown, the ESD protection circuit 402 may be a combination of the gate ESD protection circuit 202 and the drain ESD protection circuit 302, described above, where the gate ESD protection circuit 202 and the drain ESD protection circuit 302 are connected via a backside ground (BACKSIDE_GND). Thus, the backside ground may be equivalent to the ground node (GND) shown in FIGS. 2 and 3. It is also noted that while numbering of some of the circuit elements shown in FIG. 4, in particular with respect to the gate ESD protection circuit 202 portion of the ESD protection circuit 402, has changed with respect to previously used numbering, the type and functionality of the illustrated circuit elements remains the same as previously described. For example, the transistors Q3, Q4 are substantially the same as the transistors Q1, Q2 of FIG. 2, the diodes D4, D5, D6, D7 are substantially the same as the diodes D1, D2, D3, D4 of FIG. 2, the diode D8 is substantially the same as the diode D5 of FIG. 2, the resistors R3, R4 are substantially the same as the resistors R1, R2 of FIG. 2, and the capacitors C3, C4 are substantially the same as the capacitors C1, C2 of FIG. 2.

As a combination of the gate ESD protection circuit 202 and the drain ESD protection circuit 302, the ESD protection circuit 402 provides protection for both a drain of the first stage of a multi-stage amplifier ‘Drain 1’ coupled to the drain pad (PAD_DRAIN1) and a gate of the first stage of a multi-stage amplifier ‘Gate 1’ coupled to the gate pad (PAD_GATE1), similar to the examples discussed above. Similar ESD protection circuits, protecting both the drain and the gate, of other stages of a multi-stage amplifier may also be implemented. Moreover, the configuration of the ESD protection circuit 402 provides ESD protection between the drain (e.g., Drain 1) and the gate (e.g., Gate 1) of the same stage of the multi-stage amplifier. An ESD strike between the drain and the gate of the same stage of the multi-stage amplifier may be considered as a worst-case ESD strike, in some examples, because the path between the drain pad (PAD_DRAIN1) and the gate pad (PAD_GATE1) generally has the most diodes in series. However, as compared to at least some existing ESD protection circuits, the ESD protection circuit 402 eliminates a significant number of diodes (e.g., such as between five and seven diodes) in the path between the drain pad and the gate pad by employing the triggerless ESD protection scheme described herein.

In the ESD protection circuit 402, the transistors Q1 and Q3 are each coupled to and controlled by the gate signal of Gate 2 and the transistors Q2 and Q4 are coupled to and controlled by the gate signal of Gate 3, in a manner similar to that described above. During normal operating conditions, the ESD protection circuit 402 normally remains in an off-state (e.g., not conducting current). As previously discussed, one or both of the gate signals of Gate 2 and Gate 3 that are coupled to the gate of the transistors Q1, Q2, Q3, Q4 may be set to a negative gate voltage during normal operation (e.g., when there is no ESD strike). The negative gate voltage provided at Gate 2 and/or Gate 3 is thus advantageously used to keep the transistors Q1, Q2, Q3, Q4 in an off-state (or at least a partially off-state) during normal operation, thereby reducing the total number of series diodes needed between the node ‘B’ and the backside ground, and between the node ‘A’ and the gate pad, to ensure a substantially fully off-state of the transistors Q1, Q2, Q3, Q4.

During a positive ESD strike between the backside ground and the gate pad (PAD_GATE1), between the backside ground and Gate 2, between the backside ground and Gate 3, or between the drain pad (PAD_DRAIN1) and the backside ground, between the drain pad (PAD_DRAIN1) and Gate 2, between the drain pad (PAD_DRAIN1) and Gate 3, the ESD protection circuit 402 may operate in a manner similar to that described above with reference to FIGS. 2 and 3. In the worst-case positive ESD strike between the drain pad (PAD_DRAIN1) and the gate pad (PAD_GATE1), the drain pad is the high pin and the gate pad is the low pin, and all other pins are floating including the backside ground, Gate 2, and Gate 3. As a result, each of the transistors Q1, Q2, Q3, Q4 will be turned on (be in an on-state) to provide a minimum resistance path to ground for the ESD strike. In such an example, the current will first flow through both parallel current paths 304, 306 (through each of the transistors Q1, Q2 and the two diodes D1-D2) and then through both parallel current paths 204, 206 (through each of the transistors Q3, Q4 and the four diodes D4-D7) to effectively sink the ESD current. In particular, the total number of diodes in the path between the drain pad and the gate pad is significantly reduced, as compared to existing implementations, through use of the triggerless ESD protection scheme provided by advantageously employing the negative gate voltage at the gate signals of Gate 2 and/or Gate 3, as discussed above. In addition, the two parallel current paths 304, 306 of the drain ESD protection circuit 302 portion of the ESD protection circuit 402, and the two parallel current paths 204, 206 of the gate ESD protection circuit 202 portion of the ESD protection circuit 402, provide redundancy in the case of an ESD strike between other pairs of pins, as previously discussed.

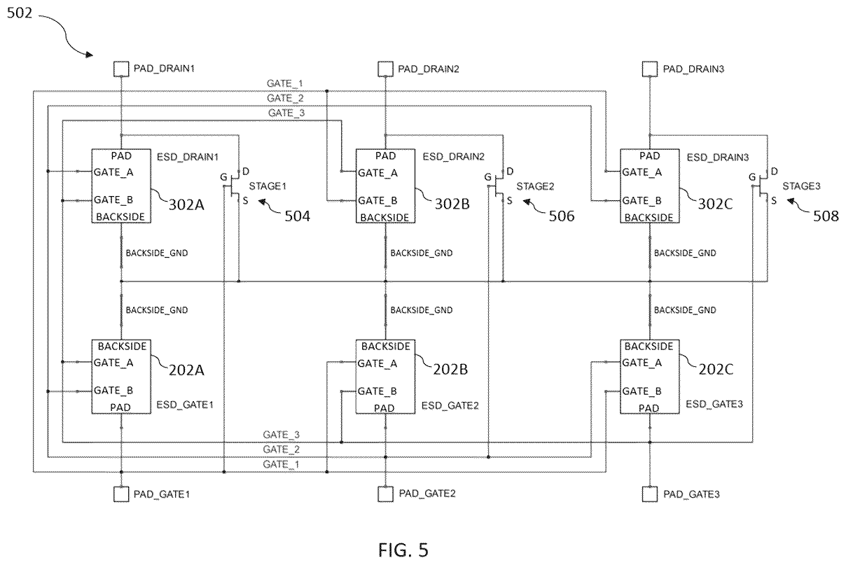

With reference to FIG. 5, illustrated therein is an exemplary circuit diagram of a monolithic microwave integrated circuit (MMIC) 502 including a multi-stage amplifier (e.g., such as a multi-stage LNA or multi-stage PA) and an ESD protection circuit, in accordance with some embodiments. In some examples, the MMIC 502 may be the IC die 100, described above. As shown, the MMIC 502 includes three amplifier stages (STAGE1, STAGE2, STAGE3), with each stage represented as a single depletion mode GaN transistor 504 (STAGE1), 506 (STAGE2), 508 (STAGE3). In the example shown, a first drain ESD protection circuit 302A protects the drain of the transistor 504, a second drain ESD protection circuit 302B protects the drain of the transistor 506, and a third drain ESD protection circuit 302C protects the drain of the transistor 508. The drain ESD protections circuits 302A, 302B, 302C may be substantially the same as the drain ESD protection circuit 302, described above. In FIG. 5, the ‘PAD’ connection of the first drain ESD protection circuit 302A is coupled to the drain pad (PAD_DRAIN1) that is also coupled to the drain of the transistor 504, the ‘PAD’ connection of the second drain ESD protection circuit 302B is coupled to the drain pad (PAD_DRAIN2) that is also coupled to the drain of the transistor 506, and the ‘PAD’ connection of the third drain ESD protection circuit 302C is coupled to the drain pad (PAD_DRAIN3) that is also coupled to the drain of the transistor 508. Further, the ‘BACKSIDE’ connection of each of the first drain ESD protection circuit 302A, the second drain ESD protection circuit 302B, and the third drain ESD protection circuit 302C is coupled to the backside ground (BACKSIDE_GND). The ‘GATE_A’ and ‘GATE_B’ connections of the first drain ESD protection circuit 302A are coupled to the gate of the transistor 506 (labeled as ‘GATE_2’) and the gate of the transistor 508 (labeled as ‘GATE_3’), respectively. The ‘GATE_A’ and ‘GATE_B’ connections of the second drain ESD protection circuit 302B are coupled to the gate of the transistor 504 (labeled as ‘GATE_1’) and the gate of the transistor 508 (GATE_3), respectively. The ‘GATE_A’ and ‘GATE_B’ connections of the third drain ESD protection circuit 302C are coupled to the gate of the transistor 504 (GATE_1) and the gate of the transistor 506 (GATE_2), respectively.

As further shown in the example of FIG. 5, a first gate ESD protection circuit 202A protects the gate of the transistor 504, a second gate ESD protection circuit 202B protects the gate of the transistor 506, and a third gate ESD protection circuit 202C protects the gate of the transistor 508. The gate ESD protections circuits 202A, 202B, 202C may be substantially the same as the gate ESD protection circuit 202, described above. In the illustrated embodiment, the ‘PAD’ connection of the first gate ESD protection circuit 202A is coupled to the gate pad (PAD_GATE1) that is also coupled to the gate of the transistor 504, the ‘PAD’ connection of the second gate ESD protection circuit 202B is coupled to the gate pad (PAD_GATE2) that is also coupled to the gate of the transistor 506, and the ‘PAD’ connection of the third gate ESD protection circuit 202C is coupled to the gate pad (PAD_GATE3) that is also coupled to the gate of the transistor 508. In addition, the ‘BACKSIDE’ connection of each of the first gate ESD protection circuit 202A, the second gate ESD protection circuit 202B, and the third gate ESD protection circuit 202C is coupled to the backside ground (BACKSIDE_GND). The ‘GATE_A’ and ‘GATE_B’ connections of the first gate ESD protection circuit 202A are coupled to the gate of the transistor 506 (GATE_2) and the gate of the transistor 508 (GATE_3), respectively. The ‘GATE_A’ and ‘GATE_B’ connections of the second gate ESD protection circuit 202B are coupled to the gate of the transistor 504 (GATE_1) and the gate of the transistor 508 (GATE_3), respectively. The ‘GATE_A’ and ‘GATE_B’ connections of the third gate ESD protection circuit 202C are coupled to the gate of the transistor 504 (GATE_1) and the gate of the transistor 506 (GATE_2), respectively.

By connecting the gate and drain of each of the transistors 504, 506, 508 to respective ones of the first, second, and third drain ESD protection circuits 302A, 302B, 302C and to respective ones of the first, second, and third gate ESD protection circuits 202A, 202B, 202C, as shown in the MMIC 502 of FIG. 5, each of the gate and drain ESD protection circuits will have at least one minimum resistance path to ground for the ESD strike, provided by at least one of the transistors Q1, Q2 in the drain ESD protection circuits 302A, 302B, 302C and by at least one of the transistors Q3, Q4 in the gate ESD protection circuits 202A, 202B, 202C. In various embodiments, this enables the drain ESD protection circuits 302A, 302B, 302C and the gate ESD protection circuits 202A, 202B, 202C to provide a minimum of 1,500V HBM of protection at the respective drain and gate pads to which they are connected. This level of protection, in some embodiments, may be about six times greater than the minimum protection provided in at least some existing implementations (250V HBM). It is noted that in embodiments including a two stage amplifier, a dummy gate pad may be used simply for ESD purposes to ensure that two separate gate signals are provided to control the drain and gate ESD protection circuits in each of the two amplifier stages.

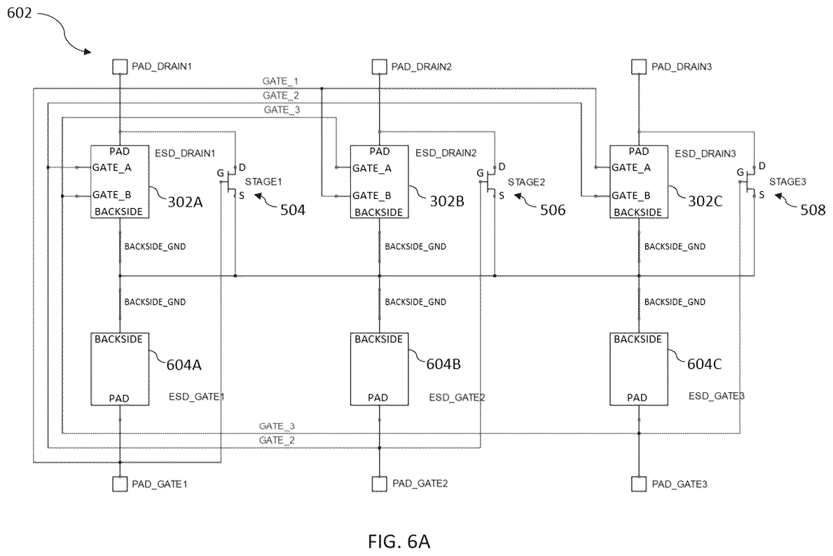

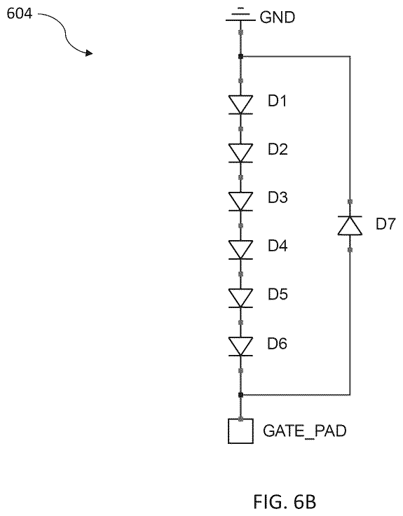

Referring to FIG. 6A, illustrated therein is an exemplary circuit diagram of a MMIC 602 including a multi-stage amplifier (e.g., such as a multi-stage LNA or multi-stage PA) and an ESD protection circuit, in accordance with some embodiments. In some examples, the MMIC 602 may be the IC die 100, described above. Further, the MMIC 602 may be similar to the MMIC 502, discussed above, except for the implementation of the gate ESD protection circuits. For example, in some embodiments, rather than use the gate ESD protection circuits 202A, 202B, 202C disclosed herein (as in the MMIC 502), the MMIC 602 may instead use a more conventional gate diode stack for the gate ESD protection circuits to simplify connections of the MMIC 602. As shown, a first gate ESD protection circuit 604A protects the gate of the transistor 504, a second gate ESD protection circuit 604B protects the gate of the transistor 506, and a third gate ESD protection circuit 604C protects the gate of the transistor 508. The gate ESD protections circuits 604A, 604B, 604C may be substantially the same as gate ESD protection circuit 604, shown and described with reference to FIG. 6B. Specifically, FIG. 6B illustrates a high pin (GND), a low pin (GATE_PAD), and a diode stack having six diodes D1, D2, D3, D4, D5, D6 connected in series between the high pin and the low pin, with an anode of the diode D1 connected to the high pin and the cathode of the diode D6 connected to the low pin. Without the triggerless ESD protection scheme, the gate ESD protection circuit 604 uses additional diodes to ensure that the diode stack does not forward bias at a negative pinch-off voltage when the transistor of the particular amplifier stage is turned off. In some examples, the gate ESD protection circuit 604 also includes diode D7 oriented in a reverse direction as compared to the diodes D1-D6, where an anode of the diode D7 is connected to the low pin (GATE_PAD) and a cathode of the diode D7 is connected to the high pin (GND). The diode D7 provides protection during a negative ESD strike between the low pin and the high pin.

While in the example of the MMIC 602 of FIG. 6A, the simplified gate ESD protections circuits 604A, 604B, 604C are used, the drain ESD protection circuits 302A, 302B, 302C remain connected in the MMIC 602 as previously described with reference to FIG. 5. Thus, in the MMIC 602 of FIG. 6A, by connecting the drain of each of the transistors 504, 506, 508 to respective ones of the first, second, and third drain ESD protection circuits 302A, 302B, 302C, each of the drain ESD protection circuits will have at least one minimum resistance path to ground for the ESD strike, provided by at least one of the transistors Q1, Q2 in the drain ESD protection circuits 302A, 302B, 302C. As such, this enables the drain ESD protection circuits 302A, 302B, 302C to provide a minimum of 1,500V HBM of protection at the respective drain pads to which they are connected. As noted above, this level of protection, in some embodiments, may be about six times greater than the minimum protection provided in at least some existing implementations (250V HBM). It is noted that in embodiments including a two stage amplifier, a dummy gate pad may be used simply for ESD purposes to ensure that two separate gate signals are provided to control the drain ESD protection circuits in each of the two amplifier stages.

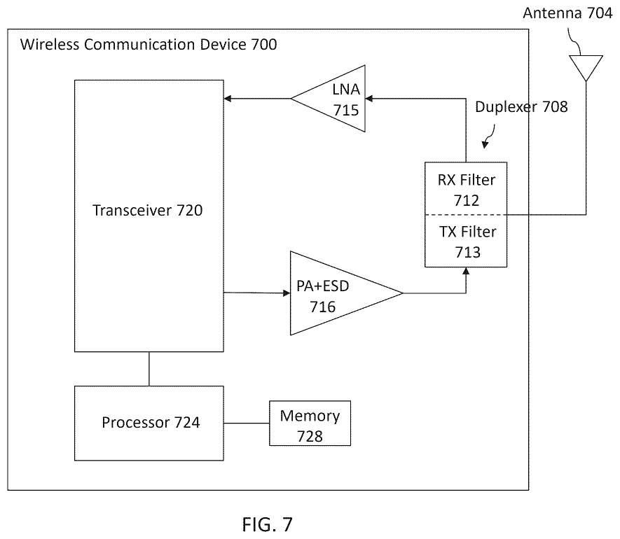

As discussed above, with reference to FIG. 1, the ESD protection circuit 102 may be employed to protect the internal circuitry 104, where the internal circuitry 104 includes GaN-based devices and circuits, such as GaN-based depletion mode devices and circuits. Further, such GaN-based devices and circuits may include, in various examples, PAs, switches, mixers, LNAs, filters, duplexers, multiplexers, modulators, multipliers, transceivers, or other GaN-based circuits and/or devices. In some embodiments, such GaN-based circuits and/or devices may be employed in a wide range of applications such as in radars, satellite communications, datalinks, base stations, mobile devices, etc. As merely one example, and with reference to FIG. 7, illustrated therein is a wireless communication device 700, which implements the ESD protection circuit 102. In some embodiments, the ESD protection circuit 102 implemented in the wireless communication device 700 may include the gate ESD protection circuit 202, the drain ESD protection circuit 302, or the gate/drain combination ESD protection circuit 402. The wireless communication device 700 may have an antenna 704, a duplexer 708 (containing a receive (RX) filter 712 and a transmit (TX) filter 713), a PA (with ESD protection) 716, an LNA 715, a transceiver 720, a processor 724, and a memory 728, coupled with each other at least as shown. For purposes of this discussion, and in some examples, the PA (with ESD protection) 716 includes the MMIC 502 or the MMIC 602 having the multi-stage amplifier and ESD protection circuits, as described above.

The antenna 704 may include one or more antennas to transmit and receive radio frequency (RF) signals over the air. The antenna 704 may be coupled with the duplexer 708 that operates to selectively couple the antenna 704 with the LNA 715 or the PA (with ESD protection) 716. When transmitting outgoing RF signals, the TX filter 713 may couple the antenna 704 with the PA (with ESD protection) 716. When receiving incoming RF signals, the RX filter 712 may couple the antenna 704 with the LNA 715. In some embodiments, the RX and TX filters 712 and 713 may include a first plurality of series resonators and a second plurality of resonators. The RX filter 712 may filter the RF signals received from the antenna 704 and pass portions of the RF signals within a predetermined bandpass to the transceiver 720.

When transmitting outgoing RF signals, the duplexer 708 may couple the antenna 704 with the PA (with ESD protection) 716. The PA (with ESD protection) 716 may receive RF signals from the transceiver 720, amplify the RF signals, and provide the RF signals to the antenna 704 for over-the-air transmission. The PA (with ESD protection) 716 is protected from ESD events by the internally embedded ESD protection circuits, as previously described. In some embodiments, the PA (with ESD protection) 716 may be provided on a single chip or IC die, such as the IC die 100 of FIG. 1. In other examples, other components of the wireless communication device (e.g., such as the LNA 715) may similarly include embedded ESD protection.

The processor 724 may execute a basic operating system program, stored in the memory 728, in order to control the overall operation of the wireless communication device 700. For example, the processor 724 may control the reception of signals and the transmission of signals by transceiver 720. The processor 724 may be capable of executing other processes and programs resident in the memory 728 and may move data into or out of the memory 728, as desired by an executing process.

The transceiver 720 may receive outgoing data (e.g., voice data, web data, c-mail, signaling data, etc.) from the processor 724, may generate RF signals to represent the outgoing data, and provide the RF signals to the PA (with ESD protection) 716. Conversely, the transceiver 720 may receive RF signals from the RX filter 712 that represent incoming data. The transceiver 720 may process the RF signals and send incoming signals to the processor 724 for further processing.

In various embodiments, the wireless communication device 700 may be, but is not limited to, a mobile telephone, a paging device, a personal digital assistant, a text-messaging device, a portable computer, a desktop computer, a base station, a subscriber station, an access point, a radar, a satellite communication device, or any other device capable of wirelessly transmitting/receiving RF signals.

Those skilled in the art will recognize that the wireless communication device 700 is given by way of example and that, for simplicity and clarity, only as much of the construction and operation of the wireless communication device 700 as is necessary for an understanding of the embodiments is shown and described. Various embodiments contemplate any suitable component or combination of components performing any suitable tasks in association with wireless communication device 700, according to particular needs. Moreover, it is understood that the wireless communication device 700 should not be construed to limit the types of devices in which the embodiments disclosed herein may be implemented.

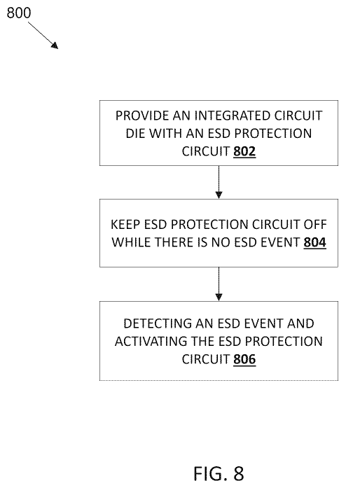

Referring to FIG. 8, illustrated is a method 800 of protecting internal circuitry of an IC die using an ESD protection circuit, in accordance with some embodiments. It will be understood that additional process steps may be implemented before, during, and after the method 800, and some process steps described may be replaced or eliminated in accordance with various embodiments of the method 800.

The method 800 begins at block 802 where an IC die with an ESD protection circuit is provided. In some embodiments, the IC die may be the IC die 100, the MMIC 502, or the MMIC 602, discussed above, and the ESD protection circuit may be the gate ESD protection circuit 202, the drain ESD protection circuit 302, or the gate/drain combination ESD protection circuit 402, discussed above. The ESD protection circuit, as previously discussed, provides two parallel current paths which are controlled by two separate gate signals and which provide redundance in the case of an ESD strike between diverse pairs of pins. The ESD protection circuit also provides triggerless operation, as discussed above, which is provided by advantageous use of the negative gate voltage at the two separate gate signals used for control of the two parallel current paths.

The method proceeds to block 804 where the ESD protection circuit remains in an off-state (e.g., not conducting current) until an ESD event occurs. That is, while there is no ESD event, the IC die 100, the MMIC 502, or the MMIC 602 operates as normal and the ESD protection circuit does not interfere with the normal operations of the IC die 100, the MMIC 502, or the MMIC 602. For example, during normal operation the negative gate voltage at the two separate gate signals (used for control of the two parallel current paths) is advantageously used to keep the transistors in the two parallel current paths in an off-state (or at least a partially off-state) and thereby reducing the total number of series diodes needed in the two parallel current paths to ensure a substantially fully off-state of the transistors in the two parallel current paths.

The method 800 proceeds to block 806 where an ESD event is detected, and the ESD protection circuit is activated. For example, when the ESD protection circuit includes a gate ESD protection circuit (e.g., such as the gate ESD protection circuit 202 of FIG. 2), and during a positive ESD strike between the high pin (GND) and the low pin (PAD_GATE1), Gate 2 and Gate 3 will be floating, thereby ensuring that the two transistors Q1, Q2 will be turned on to provide a minimum resistance path to ground for the ESD strike. During a positive ESD strike between the high pin (GND) and Gate 2, Gate 3 will remain floating, ensuring that the transistor Q2 will be turned on and current will flow primarily through the current path 206 to still effectively sink the ESD current. During a positive ESD strike between the high pin (GND) and Gate 3, Gate 2 will remain floating, ensuring that the transistor Q1 will be turned on and current will flow primarily through the current path 204 to once again effectively sink the ESD current. Thus, the gate ESD protection circuit ensures at least one minimum resistance path to ground for the ESD strike, provided by at least one of the transistors in the two parallel current paths.

In another example, when the ESD protection circuit includes a drain ESD protection circuit (e.g., such as the drain ESD protection circuit 302 of FIG. 3), and during a positive ESD strike between the high pin (PAD_DRAIN1) and the low pin (GND), Gate 2 and Gate 3 will be floating, thereby ensuring that the two transistors Q1, Q2 will be turned on to provide a minimum resistance path to ground for the ESD strike. During a positive ESD strike between the high pin (PAD_DRAIN1) and Gate 2, Gate 3 will remain floating, ensuring that the transistor Q2 will be turned on and current will flow primarily through the current path 306 to still effectively sink the ESD current. During a positive ESD strike between the high pin (PAD_DRAIN1) and Gate 3, Gate 2 will remain floating, ensuring that the transistor Q1 will be turned on and current will flow primarily through the current path 304 to once again effectively sink the ESD current. Thus, the drain ESD protection circuit ensures at least one minimum resistance path to ground for the ESD strike, provided by at least one of the transistors in the two parallel current paths.

In still another example, when the ESD protection circuit includes a gate/drain combination ESD protection circuit (e.g., such as the gate/drain combination ESD protection circuit 402 of FIG. 4), and during a positive ESD strike between the high pin (PAD_DRAIN1) and the low pin (PAD_GATE1), all other pins are floating including the backside ground, Gate 2, and Gate 3. As a result, each of the transistors Q1, Q2, Q3, Q4 will be turned on (be in an on-state) to provide a minimum resistance path to ground for the ESD strike. In such an example, the current will flow through both parallel current paths in each of the drain ESD protection circuit portion and the gate ESD protection circuit portion, of the gate/drain combination ESD protection circuit, to effectively sink the ESD current. As previously noted, the total number of diodes in the path between the drain pad (high pin) and the gate pad (low pin) is significantly reduced, as compared to existing implementations, through use of the triggerless ESD protection scheme disclosed herein.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An electro-static discharge (ESD) protection circuit, comprising:
a first transistor and a second transistor connected in parallel between a high pin and a central node; and
a first diode connected between the central node and a low pin;
wherein a first gate signal is coupled to a first gate of the first transistor, and wherein a second gate signal is coupled to a second gate of the second transistor.

2. The ESD protection circuit of claim 1, wherein the first transistor and the second transistor each comprise a depletion mode gallium nitride (GaN) transistor.

3. The ESD protection circuit of claim 1, wherein a first drain of the first transistor and a second drain of the second transistor are connected to the high pin, and wherein a first source of the first transistor and a second source of the second transistor are connected to each other via the central node.

4. The ESD protection circuit of claim 1, further comprising a second diode connected in series with the first diode, wherein an anode of the first diode is connected to the central node, and wherein a cathode of the second diode is connected to the low pin.

5. The ESD protection circuit of claim 1, wherein the high pin comprises a drain pad that is further coupled to a drain of a third transistor protected by the ESD protection circuit.

6. The ESD protection circuit of claim 1, wherein the low pin comprises a ground node.

7. The ESD protection circuit of claim 4, wherein the first transistor, the first diode, and the second diode provide a first current path between the high pin and the low pin, wherein the second transistor, the first diode, and the second diode provide a second current path between the high pin and the low pin, and wherein the first current path is parallel to the second current path.

8. The ESD protection circuit of claim 1, further comprising:
a first resistor coupled in series between the first gate signal and the first gate of the first transistor; and
a second resistor coupled in series between the second gate signal and the second gate of the second transistor.

9. The ESD protection circuit of claim 1, wherein the ESD protection circuit is coupled to a first stage of a multi-stage amplifier, wherein the first gate signal corresponds to a second stage of the multi-stage amplifier, and wherein the second gate signal corresponds to a third stage of the multi-stage amplifier.

10. The ESD protection circuit of claim 4, further comprising:
a third diode, wherein an anode of the third diode is connected to the low pin, and wherein a cathode of the third diode is connected to the high pin.

11. A method, comprising:
providing an electro-static discharge (ESD) protection circuit comprising a first transistor and a second transistor connected in parallel between a high pin and a central node, wherein the ESD protection circuit further comprises a first diode and a second diode connected in series between the central node and a low pin, wherein a first gate signal is coupled to a first gate of the first transistor, and wherein a second gate signal is coupled to a second gate of the second transistor; and
in response to an ESD event, causing ESD current to flow through one or both of a first current path between the high pin and the low pin and a second current path between the high pin and the low pin, wherein the first transistor, the first diode, and the second diode provide the first current path, and wherein the second transistor, the first diode, and the second diode provide the second current path.

12. The method of claim 11, wherein the ESD event comprises a positive ESD strike between the high pin and the low pin, and wherein the ESD current flows through both the first current path and the second current path.

13. The method of claim 12, wherein the positive ESD strike between the high pin and the low pin causes the first gate signal and the second gate signal to be floating.

14. The method of claim 11, wherein the ESD protection circuit is coupled to a first stage of a multi-stage amplifier, wherein the first gate signal corresponds to a gate of a second stage of the multi-stage amplifier, and wherein the second gate signal corresponds to a gate of a third stage of the multi-stage amplifier, wherein the ESD event comprises a positive ESD strike between the high pin and the gate of the second stage of the multi-stage amplifier or between the high pin and the gate of the third stage of the multi-stage amplifier, and wherein the ESD current flows through one of the first current path and the second current path.

15. The method of claim 14, wherein the positive ESD strike between the high pin and the gate of the second stage of the multi-stage amplifier or between the high pin and the gate of the third stage of the multi-stage amplifier causes one of the first gate signal and the second gate signal to be floating.

16. The method of claim 11, wherein the first transistor and the second transistor each comprise a depletion mode gallium nitride (GaN) transistor.

17. The method of claim 11, wherein the high pin comprises a drain pad that is further coupled to a drain of a third transistor protected by the ESD protection circuit, and wherein the low pin comprises a ground node.

18. An integrated circuit (IC) die, comprising:
internal circuitry; and
an electro-static discharge (ESD) protection circuit coupled to the internal circuitry;
wherein the ESD protection circuit comprises:
a first transistor and a second transistor connected in parallel between a high pin and a central node; and
a first diode and a second diode connected in series between the central node and a low pin;
wherein a first gate signal is coupled to a first gate of the first transistor, and wherein a second gate signal is coupled to a second gate of the second transistor.

19. The IC die of claim 18, wherein the internal circuitry comprises a GaN-based multi-stage amplifier.

20. The IC die of claim 18, wherein the first transistor and the second transistor each comprise a depletion mode gallium nitride (GaN) transistor.
